(19) United States
(12) Patent Application Publication
(10) Pub. No.: US 2002/0062238 A1
(43) Pub. Date: May 23, 2002

(54) Method for managing the level and reducing the volatility of a company's share price

(76) Inventor: Joseph Frank Brilando, Portola Valley, CA (US)

Correspondence Address: SKADDEN, ARPS, SLATE, MEAGHER & FLOM LLP, ATTN: JAN STEELE, 525 UNIVERSITY AVENUE, SUITE 1100, PALO ALTO, CA, 94301, US

(21) Appl. No.: 09/975,120

(22) Filed: Oct. 9, 2001

Related U.S. Application Data
(63) Continuation of application No. 09/256,811, filed on Feb. 24, 1999, now abandoned.

(51) Int. Cl. G06F 17/60

(52) U.S. Cl. 705/7

(57) ABSTRACT

The present invention provides a computerized method for systematically evaluating the drivers of a company's share price, and for making frequent small adjustments to the company's goals (as set forth in its budget and operational plans) in a manner that manages or stabilizes the level and reduces the volatility of the company's share price. In a preferred method, data representing a plurality of internal and external factors that affect the level of the company's share price are received. A subset of the received data is selected, then analyzed to estimate the absolute or relative influence of each of a plurality of factors on the level of the company's share price. Next, an estimate is generated of how changes in each of a plurality of the internal factors will affect the company's share price. This estimate is then used to make changes in the company's goals. Frequent small changes to the company's goals act as small “mid-course corrections” that reduce unnecessary share price volatility.

### BACKGROUND

The present invention relates generally to business management, and more specifically to a computerized method for managing the level of a company's share price in a manner that reduces share price volatility.

The board of directors and management of a company are responsible for maximizing the value provided to the company's shareholders. Shareholder value can be maximized by a steady increase in the market value of the company's stock (and thus share price) over time. The volatility of a company's stock is a measure of the variation in its performance over time; a stock that increases fairly steadily in market value is said to have a low volatility.

High volatility can have several negative impacts on a company's shareholders. For example, high volatility can reduce a company's market value by increasing the company's cost of capital, and by preventing certain classes of investment capital (such as low risk mutual funds and pension funds) from providing funds to the company. Volatility also penalizes shareholders who wish to sell their shares when the company's share price is below the market trend.

At any given time, a company's share price is affected (or “driven”) by several factors. Examples of internal (that is, company specific) factors that can affect a company's share price include past share price, return on net assets (RONA) or similar return on real (non-inflationary) investment ratio, earnings per share, cash flow, revenue growth rates, earnings growth rates, budget, operations plans, and market share. Examples of external investment and macroeconomic factors that can affect a company's share price include share prices of peer companies, level of one or more stock index, interest rates, Gross Domestic Product (GDP) growth rates, indices of price inflation, consumer confidence levels, third-party forecasts, international risk factors, and currency exchange rates.

At different times, and for different industries, various internal and external factors may become more or less important to a company's share price. For example, revenue growth and market share may be the strongest drivers of a newly public company's share price, whereas one or more measures of profitability may be most important to the share price of a more mature public company. FIG. 1 is a chart showing examples of company-specific factors that may affect or drive a company's share price over the company's life cycle. The internal factors that drive a company's share price may vary by industry, or may vary due to changes in investors desires, interest rates, or other external events and conditions. Changes to individual company-specific factors (such as a drop in earnings or market share), as well as changes to which factors most strongly drive a company's market value (such as a shift from market share to profitability) can lead to high share price volatility.

Enterprise Resource Planning (ERP) is currently a multi-billion dollar industry whose purpose is to ensure that a company's operations are organized and efficient. ERP software providers such as SAP, Oracle, and BAAN help companies to maximize profit and revenue growth through the acquisition and management of information regarding current and future final demand for the company's products, production and distribution efficiency, effectiveness and quality, and procurement of precise inputs of production.

Although the use of ERP software helps to reduce share price volatility caused by changes to individual company-specific factors (such as drops in earnings or profitability caused by production inefficiencies), this software does little or nothing to reduce volatility caused by changes in which company-specific factors most strongly drive a company's market value.

Understanding and responding to changes in company-specific factors that drive a company's share price is usually the responsibility of the company's senior management and board members. To minimize volatility (and thus maximize shareholder value), these individuals must modify the company's budget and other operational plans to reflect changes in the company's share price drivers. For example, if a company's profitability becomes more important to the company's share price than revenue growth, then the company should allocate fewer resources towards revenue growth, and allocate more resources towards increasing profitability.

In most companies, resolution of strategic trade-offs among revenue growth, profitability, and other company-specific factors takes place during the annual budgeting and planning process, and the trade-offs are driven by a qualitative assessment of all of the participants' viewpoints and perspectives. FIG. 2 is an example of the manner in which information may be provided to budgeting participants, and consensus rendered as to the company's financial goals.

Although typical yearly budget meetings allow a company to make changes to its goals (as set forth in its budget and operational plans) to reflect changes in the company's share price drivers, yearly, and even quarterly changes are too infrequent to minimize the company's share price volatility. Accordingly, there remains a need in the art for a method for systematically evaluating a company' share price drivers, and for making frequent small adjustments to the company's goals in a manner that manages or stabilizes the level and reduces the volatility of the company's share price.

### SUMMARY

The present invention meets this need by providing a computerized method for systematically evaluating the drivers of a company's share price, and for making frequent small adjustments to the company's goals (as set forth in its budget and operational plans) in a manner that manages or stabilizes the level and reduces the volatility of the company's share price. In a preferred method, data representing a plurality of internal and external factors that affect the level of the company's share price are received. A subset of the received data is selected, then analyzed to estimate the absolute or relative influence of each of a plurality of factors on the level of the company's share price. Next, an estimate is generated of how changes in each of a plurality of the internal factors will affect the company's share price. This estimate is then used to make changes in the company's goals. Frequent small changes to the company's goals act as small “mid-course corrections” that reduce unnecessary share price volatility.

### BRIEF DESCRIPTION OF THE DRAWINGS

FIG. 1 is a chart showing an example of the relative importance of certain company-specific share price drivers over a company's life cycle.

FIG. 2 shows an example of the manner in which information may be provided to budgeting participants.

FIG. 3 shows a preferred method for managing the level and reducing the volatility of a company's share price.

FIGS. 4 and 5 are examples of tables that reflect the trade-offs between two company-specific share price drivers: return on net assets (RONA) and sales growth.

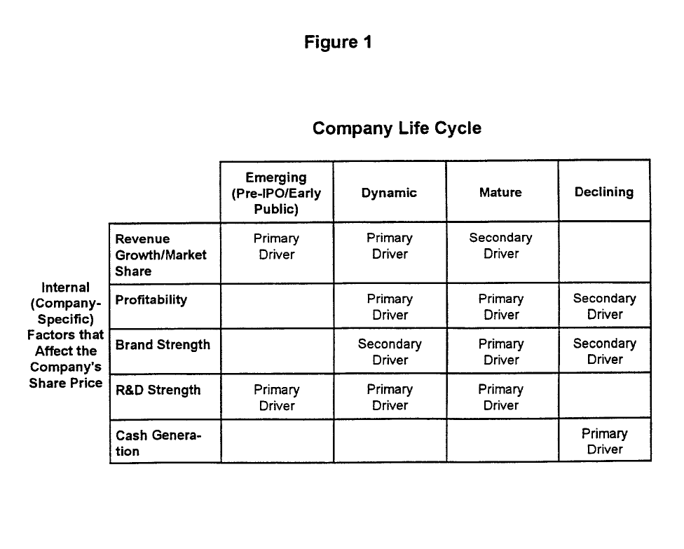

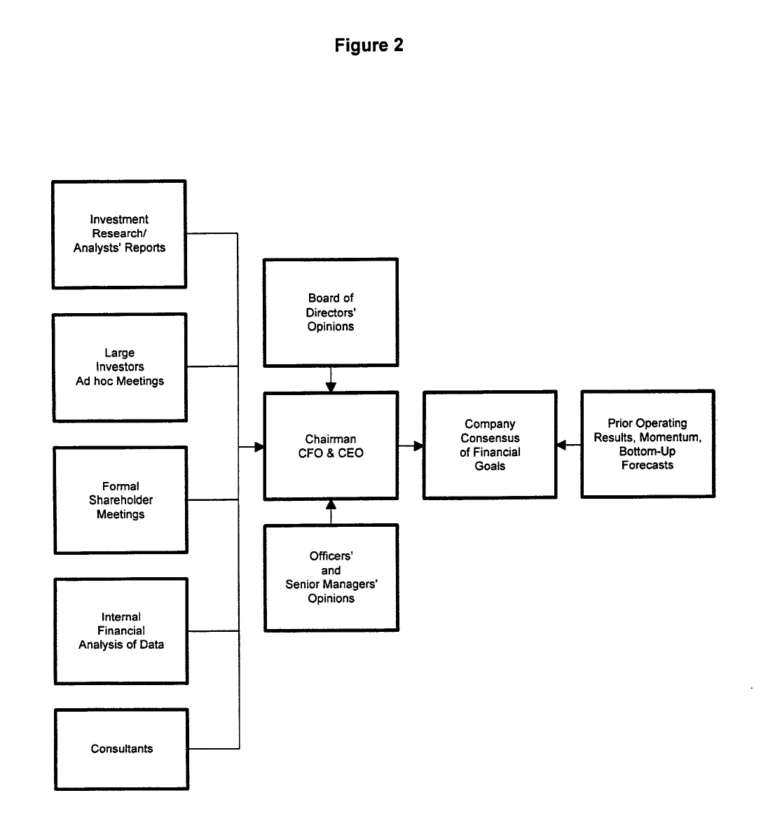

### DETAILED DESCRIPTION

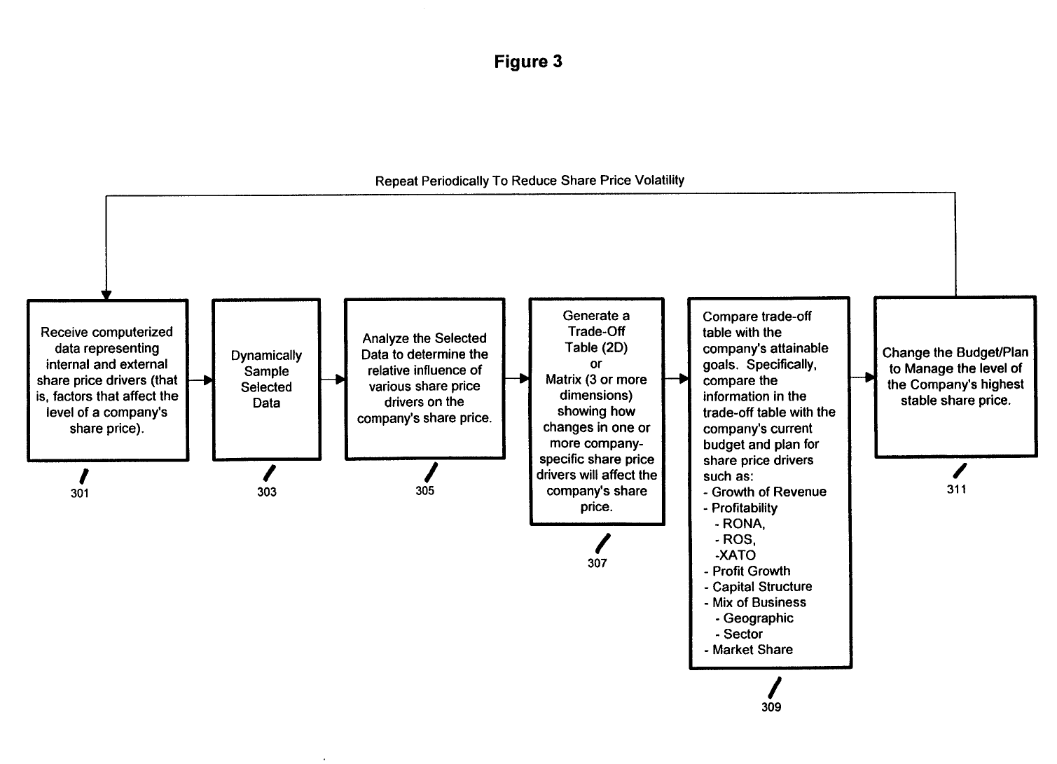

FIG. 3 illustrates a preferred method for managing the level and reducing the volatility of a company's share price. At step 301, data representing at least internal and preferably also external share price drivers (that is, data representing factors that affect the level of a company's share price) are received. The data may be received at a data warehouse, datamart, or one or more databases. As discussed above, there are several internal and external share price drivers. Internal factors that can affect a company's share price include one or more of the company's:

current share price;

past share price;

return on net assets (RONA), return on sales (ROS), times asset turns (XATO), or similar return on investment ratios;

earnings per share;

cash flow;

revenue growth rates;

earnings growth rates;

budget;

operations plans;

market share;

mix of business; and

capital structure.

External investment and macroeconomic share price drivers include one or more of:

share prices of peer companies;

level of one or more stock index;

interest rates;

GDP growth rates;

consumer confidence levels;

third-party forecasts;

and key relevant currency exchange rates.

At step 303, a subset of this data is preferably selected and sampled using one or more well known statistical sampling techniques, such as dynamic sampling used in on-line manufacturing quality control.

At step 305, the selected data is analyzed to estimate or determine the relative influence of each selected share price driver on the level and volatility of the company's share price. This analysis may be performed using well known techniques such as statistical factoring, linear regression analysis, non-linear regression analysis, binomial analysis, and fractal dimensional analysis. Examples of techniques used to estimate the absolute or relative influence of a given share price driver are included, for example, in Wonnacott & Wonnacott, Econometrics (1969), and in Peters, Fractal Market Analysis (J.Wiley & Sons, 1994), both of which are incorporated herein by reference.

Using the information determined at step 305, a trade-off table or matrix is generated at step 307. Trade-off tables contain estimates of how changes in two or more company-specific share price drivers (such as RONA, revenue growth, market share, profitability, etc.) will affect the company's share price. In a preferred embodiment, a two dimensional trade-off table is generated by taking the two share price drivers with the highest statistical significance (t-statistic) and simulating results from the regression equation for a reasonable range of values for the independent variables. A three- or four-dimensional trade-off matrix may be generated by taking the three or four share price drivers with the highest statistical significance and simulating results from the regression equation for a reasonable range of values for the independent variables. If more than four share price drivers add significance to the overall estimate (as would be shown by an increasing R-bar squared in a step-wise regression method (see Econometrics discussed above)), a higher dimensional trade-off matrix may be generated.

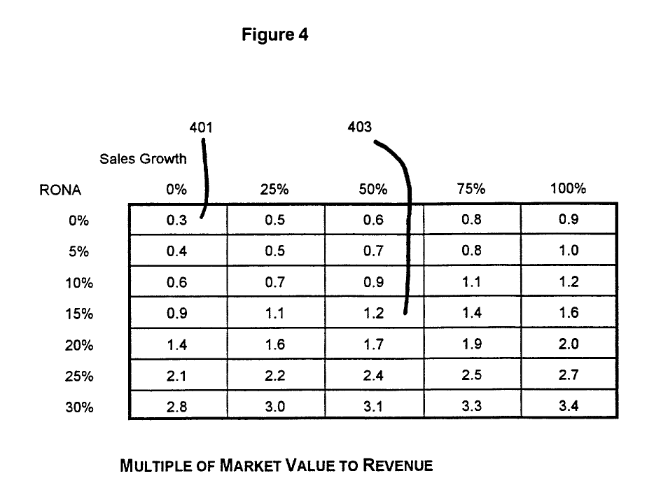

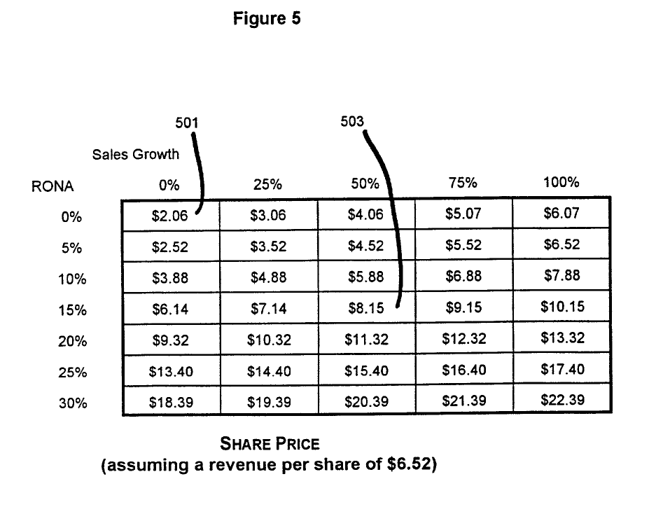

Examples of trade-off tables are shown in FIGS. 4 and 5. FIG. 4 reflects the trade-offs between return on net assets (RONA) and sales growth on the multiple of the company's market value to revenue. As is shown for example in box 401, a RONA of 0 percent and a sales growth of 0 percent would result in a multiple of market value to revenue of 0.3. And as is shown in box 403, a RONA of 15 percent and a sales growth of 50 percent would result in a multiple of market value to revenue of 1.2.

The entries in the trade-off table of FIG. 5 correspond to the entries of FIG. 4, multiplied by the company's revenue per share. In this example, it is assumed that the company has revenue per share of $6.52. As is shown for example in box 501, a RONA of 0 percent and a sales growth of 0 percent would result in a share price of $2.06. And as is shown in box 503, a RONA of 15 percent and a sales growth of 50 percent would result in a share price of $8.15. For the company represented in FIGS. 4 and 5, it can be seen that relative changes in RONA have a much greater impact on share price than the same relative changes in sales growth.

At step 309 of FIG. 3, the trade-off table generated at step 307 is compared with the company's current attainable goals as reflected in its budget and operational plans. As discussed above, the example trade-off tables of FIGS. 4 and 5 show that a relative increase in RONA will have a much greater impact on the company's share price than the same relative increase in sales growth would have. The company may therefore wish to change its budget and plans (step 311) to allocate more resources towards an increase in RONA, and reduce its resources allocated towards sales growth. This method is preferably repeated as often as is needed to reduce the volatility of the company's share price. The frequency with which it needs to be repeated depends on the company's industry, and prevailing economic conditions.

Although the invention has been described in terms of a preferred embodiment, it should be understood that various changes, substitutions, and alterations can be made to the preferred embodiment without departing from the spirit and scope of the invention as defined by the following claims.

What is claimed is:

1. A computerized method for managing the level of a company's share price, the company having a budget with budget items, and a plan for its operations, the method comprising the steps of:
(a) receiving data representing a plurality of factors that affect the level of the company's share price;
(b) analyzing the data to estimate the absolute or relative influence of at least two of the factors on the level of the company's share price;
(c) generating an estimate of how changes in at least two of the factors would affect the company's share price; and
(d) making changes in one or more of the company's budget items and/or plans in accordance with the estimate of step (c) to manage the level of the company's share price.

2. The method of claim 1 wherein the estimate of the step (c) is in the form of a trade-off table or matrix.

3. The method of claim 1 wherein the factors include company-specific share price drivers.

4. The method of claim 3 wherein the company specific share price drivers include one or More of the company's:
(a) current share price;
(b) past share price;
(c) return on net assets or similar return on investment ratio;
(d) earnings per share;
(e) cash flow;
(f) revenue growth rate;
(g) earnings growth rate;
(h) budget;
(i) operations plans;
(j) market share;
(k) mix of business; and
(l) capital structure.

5. The method of claim 1 wherein the factors include investment and macroeconomic factors.

6. The method of claim 5 wherein the investment and macroeconomic factors include one or more of:
(a) share prices of peer companies;
(b) level of one or more stock index;
(c) interest rates;
(d) GDP growth rate;
(e) consumer confidence levels;
(f) third party forecasts; and
(g) key relevant currency exchange rates and futures.

7. The method of claim 1 further comprising the steps of:
(a1) selecting a subset of the data received; and
(a2) dynamically sampling the selected data.

8. The method of claim 1 wherein the step (a) is performed at a database, data warehouse, or datamart.

9. The method of claim 1 wherein the step (b) is performed though the use of a statistical factoring method.

10. The method of claim 1 wherein the step (b) is performed though the use of linear regression analysis.

11. The method of claim 1 wherein the step (b) is performed though the use of non-linear regression analysis.

12. The method of claim 1 wherein the step (b) is performed though the use of binomial analysis.

13. The method of claim 1 wherein the step (b) is performed though the use of fractal dimensional analysis.

14. The method of claim 1 further comprising the step (e) of periodically repeating the steps (a)-(d) to reduce volatility of the company's share price.
